(19) United States
(12) Patent Application Publication
(10) Pub. No.: US 2019/0070805 A1
(43) Pub. Date: Mar. 7, 2019

(54) METHOD FOR FABRICATING OPTICAL CONNECTING DEVICE

(71) Applicant: SUMITOMO ELECTRIC INDUSTRIES, LTD., Osaka (JP)

(72) Inventors: Mitsuharu Hirano, Osaka (JP); Akira Furuya, Osaka (JP)

(73) Assignee: SUMITOMO ELECTRIC INDUSTRIES, LTD., Osaka (JP)

(21) Appl. No.: 16/121,312

(22) Filed: Sep. 4, 2018

(30) Foreign Application Priority Data
Sep. 5, 2017 (JP) 2017-170310

(51) Int. Cl. B29D 11/00; G02B 6/25; G02B 6/42

(52) U.S. Cl. CPC B29D 11/0075; G02B 6/4214; G02B 6/25

(57) ABSTRACT

A method for fabricating an optical connecting device includes: preparing a product for an optical connecting device which includes first and second parts for a holder, and optical fibers extending in a direction of a first axis between first faces of the first and second parts, the first and second parts of the product being arranged in a direction of a second axis intersecting that of the first axis, the first faces of the first part and the first face of the second part extending in the direction of the first axis and a direction of a third axis, and the third axis intersecting the direction of the first axis and the direction of the second axis; and moving one of a processing device and the product relative to the other to process the product in the direction of the second axis so as to reach the optical fibers.

### BACKGROUND OF THE INVENTION

### Field of the Invention

The present invention relates to a method for fabricating an optical connecting device. This application claims the benefit of priority from Japanese Patent Application No. 2017-170310 filed on Sep. 5, 2017, which is herein incorporated by reference in its entirety.

### Related Background Art

Japanese Patent Application Laid-Open No. 2003-337245 (Patent No. 4106616), referred to as Patent Document 1, discloses a substrate for an optical fiber array.

### SUMMARY OF THE INVENTION

A method for fabricating an optical connecting device according to one aspect of the present invention includes: preparing a product for an optical connecting device, the product including a first part and a second part for a holder, and one or more optical fibers extending in a direction of a first axis, the first part and the second part of the product being arranged in a direction of a second axis such that the one or more optical fibers are between a first face of the first part and a first face of the second part, the second axis intersecting the direction of the first axis, the first face of the first part and the first face of the second part extending in the direction of the first axis and a direction of a third axis, and the third axis intersecting the direction of the first axis and the direction of the second axis; and moving one of a processing device and the product relative to the other to process the product in the direction of the second axis so as to reach the optical fibers.

### BRIEF DESCRIPTION OF THE DRAWINGS

The above-described objects and the other objects, features, and advantages of the present invention become more apparent from the following detailed description of the preferred embodiments of the present invention proceeding with reference to the attached drawings.

FIG. 1A is a view showing a major step in a method for fabricating an optical connecting device according to the embodiment.

FIG. 1B is a view showing a major step in the method according to the embodiment.

FIG. 2A is a view showing a major step in the method according to the embodiment.

FIG. 2B is a view showing a major step in the method according to the embodiment.

FIG. 3A is a view showing a major step in the method according to the embodiment.

FIG. 3B is a view showing a major step in the method according to the embodiment.

FIG. 4A is a schematic view showing a major step for the second processing according to the embodiment.

FIG. 4B is a schematic view showing a major step for the second processing according to the embodiment.

FIG. 4C is a schematic view showing a major step for the second processing according to the embodiment.

FIG. 5A is a schematic view showing a major step for the second processing according to the embodiment

FIG. 5B is a schematic view showing a major step for the second processing according to the embodiment

FIG. 5C is a schematic view showing a major step for the second processing according to the embodiment

FIG. 6A is a view showing a major step in the method according to the embodiment.

FIG. 6B is a view showing a major step in the method according to the embodiment.

FIG. 7A is a view showing the appearance of the optical connecting device according to the present embodiment.

FIG. 7B is a view showing the appearance of the optical connecting device according to the present embodiment.

FIG. 7C is a view showing the appearance of the optical connecting device according to the present embodiment.

FIG. 7D is a view showing the appearance of the optical connecting device according to the present embodiment.

### DESCRIPTION OF THE PREFERRED EMBODIMENTS

The two optical connectors mate with each other at the end faces thereof. Connecting the optical connectors with each other enables the optical coupling between optical fibers in the respective optical connectors. The inventors' findings reveal that an optical connecting device, such as an optical connector, can be optically coupled to a semiconductor device, which has optical coupling elements. Specifically, the optical connector directs the end face thereof toward the top face of the semiconductor device in a manner similar to the optical coupling between optical connectors. The optical connector is optically coupled to optical coupling elements of the semiconductor device at the tips of the optical fibers on the end face thereof to form an optical connecting apparatus including the optical connector and the semiconductor device. The optical connecting apparatus thus formed has a minimal height which is the sum of the thickness of the semiconductor device and the length of the optical connecting device, and this summation may determine the height of the optical connecting apparatus. The inventors' studies reveal that the optical connecting device has a thickness smaller than the length of the optical connecting device. The difference in dimension between these values may make the height of the optical connecting apparatus small in arranging semiconductor device and the optical connecting device such that the optical fibers of the optical connecting device are coupled to the semiconductor device through the side face of the optical connecting device. This arrangement of the semiconductor device and the optical connecting device makes their optical coupling therebetween difficult because this optical-coupling causes light propagating through each optical fiber to pass through the side of the optical fiber, but may provide the optical connecting apparatus with a reduced height.

It is an object of one aspect of the present invention to provide a method for fabricating an optical connecting device, which can provide the optical connecting device with an optical coupling side face disposed in the cladding of an optical fiber thereof.

A description will be given of embodiments below.

A method for fabricating an optical connecting device according to an embodiment includes: (a) preparing a product for an optical connecting device, the product including a first part and a second part for a holder, and one or more optical fibers extending in a direction of a first axis, the first part and the second part of the product being arranged in a direction of a second axis such that the one or more optical fibers are between a first face of the first part and a first face of the second part, the second axis intersecting the direction of the first axis, the first face of the first part and the first face of the second part extending in the direction of the first axis and a direction of a third axis, and the third axis intersecting the direction of the first axis and the direction of the second axis; and (b) moving one of a processing device and the product relative to the other to process the product in the direction of the second axis so as to reach the optical fibers.

The method for fabricating an optical connecting device includes moving one of the device and the product, which includes the first and second parts arranged in the direction of the second axis that intersects that of the first axis in which each optical fiber extends, relative to the other to process the product in the direction of the second axis. This processing in the direction of the second axis allows the processing device to reach the side of the cladding of the optical fiber that extends in the direction of the first axis, and is followed by a further processing, which is applied to the optical fiber, with the processing device in a direction from the side of the cladding to the core. The further processing is stopped at the endpoint thereof to bring the cladding face to completion.

The method according to an embodiment further includes, prior to moving one of the processing device and the product relative to the other to process the product, positioning the first face of the first part of the product to the processing device.

In the method for fabricating the optical connecting device, positioning the processing device to the first face of the first part of the product can determine the amount of the processing, which machine the cladding of the optical fiber with the processing device, with reference to the first face of the product. The first face of the first part used as a reference is near the optical fiber.

In the method according to an embodiment, moving one of a processing device and the product relative to the other to process the product includes moving the processing device to process the first part of the product to an endpoint, and the endpoint is determined with respect to the first face of the product.

The method for fabricating the optical connecting device uses the first face of the first part as a reference to estimate a distance from an initial position of the processing device to the optical fiber. Moving one of the product, which includes the first and second parts arranged in the direction of the second axis, and the processing device relative to the other by a predetermined distance can process the first part, so that the processing device reaches the side face of the optical fiber, which extends in the direction of the first axis.

In the method according to an embodiment, the first face of the first part includes an area having a width larger than that of the first face of the second part in the direction of the third axis.

In the method for fabricating the optical connecting device, the first part in the product may have side ends that protrude outward with reference to the respective sides of the second part. Providing the first part with a wide first face easily determine the distance between the initial position of the processing device and the optical fiber.

The method according to an embodiment, the first face of the first part has a first width, the first face of the second part has a second width smaller than that of the first width, and a difference between the first width and the second width is larger than 0.1 mm.

In the method for fabricating the optical connecting device, the first part provides the first face with a width greater than that of the first side of the second part by 0.1 millimeters. The first part, which provides the first face with a width slightly larger than that of the first face of the second part, allows the easy estimation of a value of the distance by which the processing device should move.

In the method according to an embodiment, the first face of the first part extends along a reference plane intersecting the second axis, the second part has grooves that receive the optical fibers therein, and the grooves extend in the direction of the first axis.

In the method of fabricating the optical connecting device, the first part supports the optical fibers on the first face thereof such that the optical fibers are in the grooves that are disposed on the first face of the second part. The optical fibers in the product are arranged along the first face of the first part. The first part provides its first face as a reference in the processing.

In the method according to an embodiment, the optical fibers are arranged along a first reference plane, the product has a first end and a second end that are arranged in the direction of the first axis, the first end is opposite to the second end, the first part has a first end face at the first end, and the first end face extends along a second reference plane inclined to the first reference plane, the optical fibers each have an end at the first end face, and moving one of a processing device and the product relative to the other to process the product includes processing the first end of the product.

In the method for fabricating the optical connecting device, the holder part has a first end face, which has an area inclined to the first reference plane, at the first end thereof.

In the method according to an embodiment, the product further has a reflecting member on the first end face, moving one of a processing device and the product relative to the other to process the product includes processing the reflecting member.

In the method for fabricating the optical connecting device, the reflecting member in the product is simultaneously processed by machining along with the optical fibers in the direction of the second axis. The reflecting member reflects light from the optical fibers.

Teachings of the present invention can be readily understood by considering the following detailed description with reference to the accompanying drawings shown as examples. Referring to the accompanying drawings, embodiments of a method for fabricating an optical connecting device according to the above aspects and an optical connecting device will be described below. To facilitate understanding, identical reference numerals are used, where possible, to designate identical elements that are common to the figures.

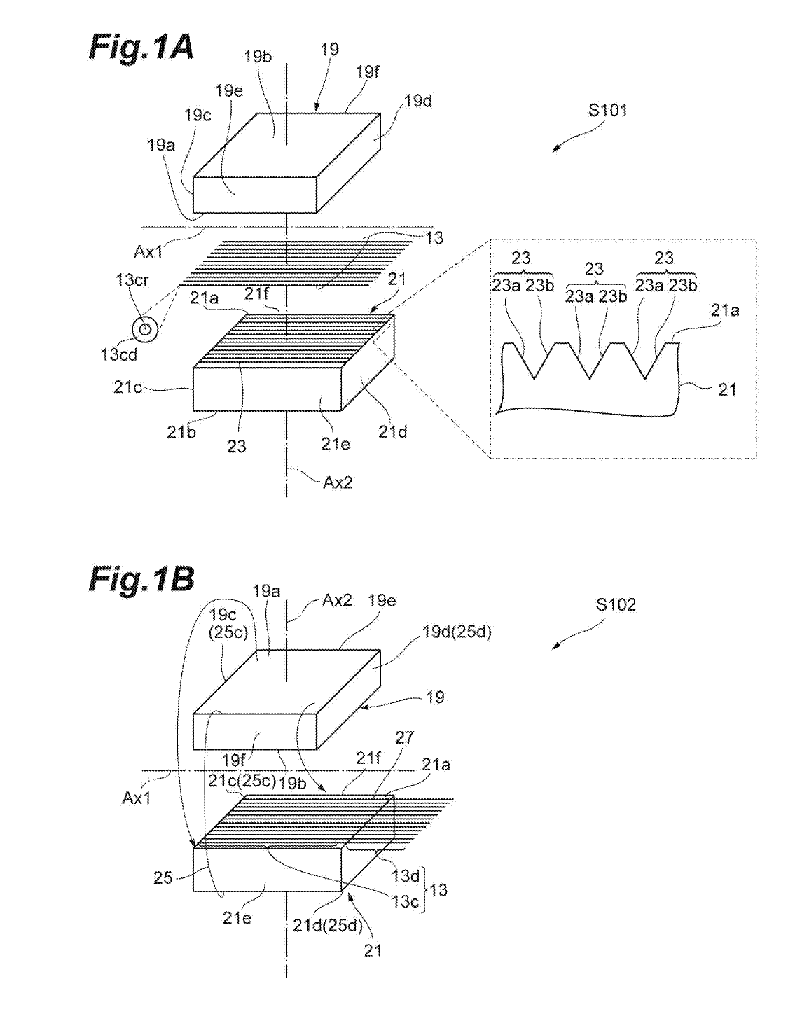

FIGS. 1A, 1B, 2A, 2B, 3A, 3B, 6A and 6B are schematic views each showing a major steps in a method for fabricating an optical connecting device according to the embodiment. The method includes preparing a product for an optical connecting device, and processing the product to form a cladding face. In the method according to the present embodiment, the product is formed in order to prepare the product (hereinafter referred to as a first intermediate product 25 shown in FIG. 1B).

Step S101 includes, as shown in FIG. 1A, preparing one or more optical fibers 13, and a first part 19 and a second part 21 for a holder. Each of the optical fibers 13 has a core region 13cr and a cladding region 13cd, and can be, for example, a single mode optical fiber. The first part 19 has a first face 19a and a second face 19b, a first end face 19c and a second end face 19d, and a first side face 19e, and a second side face 19f. The first and second faces 19a and 19b and the first and second side faces 19e and 19f extend in the direction of the first axis Ax1. The first and second end faces 19c and 19d are arranged in the direction of the first axis Ax1. The second part 21 has a first face 21a, and a second face 21b, a first end face 21c, a second end face 21d, a first side face 21e and a second side face 21f. The first and second faces 21a and 21b and the first and second side faces 21e and 21f extend in the direction of the first axis Ax1. The first and second end faces 21c and 21d are arranged in the direction of the first axis Ax1. To facilitate understanding, the figures show, in the present embodiment, the first and second parts 19 and 21 each of which has, for example, a rectangular parallelepiped shape with a width enabling a holder. The first and second parts 19 and 21 each include, for example, glass, such as Tempax (trademark) and Pyrex (trademark), quartz, or ceramic, such as alumina or zirconia. These materials can provide the product, which is formed by machining in a subsequent process, with a desired accuracy. The sizes (length, width and height) of each of the first and second parts 19 and 21 can be several millimeters.

In the present embodiment, the first face 19a of the first part 19 extends along a reference plane intersecting the direction of the second axis Ax2, which intersects the first axis Ax1, and can be substantially flat in this example. The first face 21a of the second part 21 has one or more grooves 23, which can receive the optical fibers 13 therein, and the grooves 23 each extend in the direction of the first axis Ax1. Specifically, each groove 23 includes a first supporting face 23a and a second supporting face 23b, which can support the side face of the optical fiber.

Step S102 includes producing a first intermediate product 25, as shown in FIG. 1B, from the arrangement of the first part 19, the optical fibers 13, and the second part 21. The first intermediate product 25 is provided with the first and second parts 19 and 21, an array of the optical fibers 13, and a resin 27. The first part 19, the arrangement of the optical fibers 13, and the second part 21, which are arranged in the direction of the second axis Ax2 in the first intermediate product 25, are fixed with the resin 27 to form the first intermediate product 25. The optical fibers 13 are disposed between the first and second faces 19a and 21a of the first and second parts 19 and 21, and extend in the direction of the first axis Ax1.

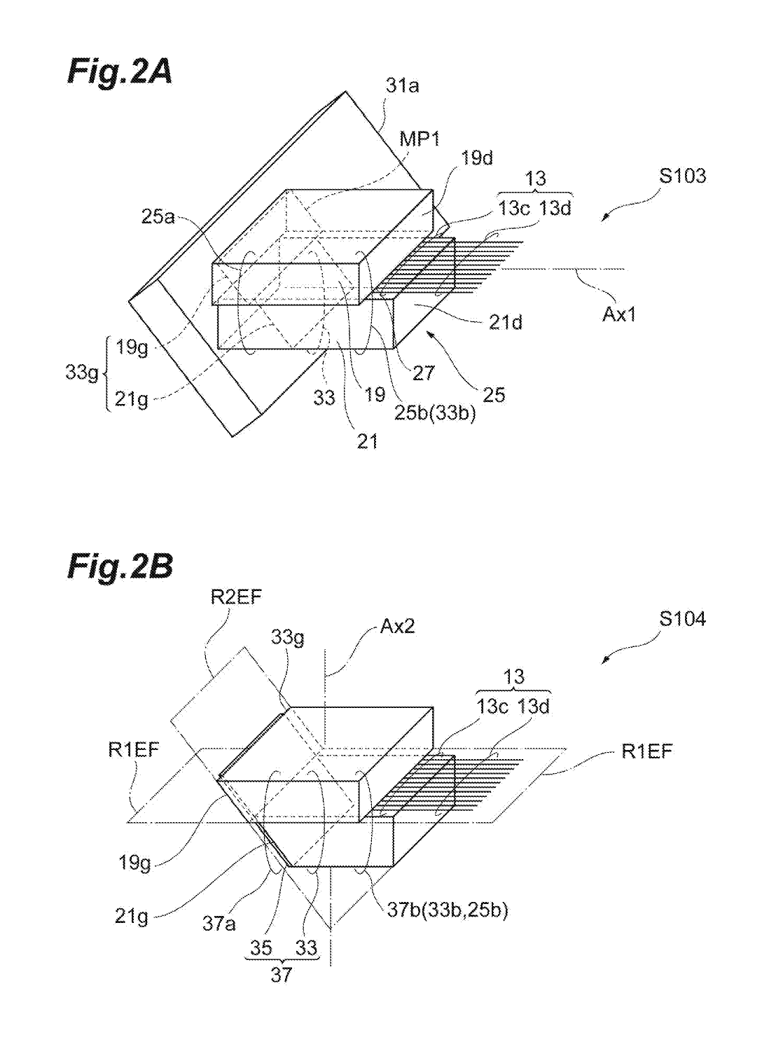

In the first intermediate product 25 according to the present embodiment, as shown in FIG. 2A, the optical fibers 13 each include a first portion 13c which is disposed between the first and second faces 19a and 21a of the first and second parts 19 and 21, and a second portion 13d which is released from the first and second parts 19 and 21. The first intermediate product 25 has a first end portion 25a and a second end portion 25b, which are arranged in the direction of the first axis Ax1. The second portions 13d of the optical fibers 13 extend from the second end portion 25b outward, which is formed by the first and second parts 19 and 21.

Step S103 includes, as shown in FIG. 2A, preparing the first intermediate product 25 and a first processing device 31a and applying a first processing with the first processing device 31a, which enables a first processing, such as polishing or grinding, to the first intermediate product 25, which includes the first part 19, the arrangement of the optical fibers 13 and the second part 21. Specifically, the first processing device 31a processes the first intermediate product 25 at the first end portion 25a thereof to form a second intermediate product (hereinafter referred to as the second intermediate product 33 shown in FIG. 2B). In an exemplary processing, the first intermediate product 25 is machined to the broken line MP1 as shown in FIG. 2A. Referring to FIGS. 2A and 2B, the second intermediate product 33 has an inclined face 33g which is formed by machining the first end portion 25a, and the inclined face 33g is opposite to the second end portion 33b (the second end 25b of the intermediate product 25). The inclined face 33g is provided with the first inclined faces 19g and 21g of the first and second parts 19 and 21, and the inclined end faces of the optical fibers 13. The inclined end faces of the optical fibers 13 each are flat sufficient to enable light reflection. Specifically, the following members are polished: the first and second parts 19 and 21; and the arrangement of the optical fibers 13 fixed with the resin 27 to the first and second parts 19 and 21.

If necessary, the second intermediate product 33 may include a reflecting member disposed on the inclined face 33g. In the present embodiment, the reflecting member is fixed to the inclined face 33g.

Step S104 includes, as shown in FIG. 2B, fixing the reflecting member 35 to the inclined face 33g to form a third intermediate product 37. The reflecting member 35 also covers the inclined end of the optical fibers 13 in the third intermediate product 37. The reflecting member 35 may include, for example, a metal film and/or a dielectric multilayer film. These films each are bonded to the base of the reflecting member 35 with resin containing, for example, an ultraviolet curing agent and/or a thermal hardening agent.

Specifically, the third intermediate product 37 allows the optical fibers 13 to extend along the first reference plane R1EF (more specifically, the first face 19a of the first part 19) that intersects the direction of the second axis Ax2. The third intermediate product 37 has a first end portion 37a and a second end portion 37b opposite to the first end portion 37a, which are aligned in the direction of the first axis Ax1. The first end portion 37a has a first end face extending along the second reference plane inclined with respect to the first reference plane, and the optical fibers each have an end, which is located on the inclined face 33g. The inclined face 33g extends along the second reference plane R2EF, which can be inclined with respect to the first reference plane R1EF at an angle of larger than zero degrees and smaller than 90 degrees.

In order to conduct the subsequent second processing, prior to the second processing, a second processing device 31b is prepared in addition to the third intermediate product 37. One of the second processing device 31b and the third intermediate product 37 is moved relative to the other with respect to the first face 19a of the first part 19 to apply the second processing to the third intermediate product 37. In order to facilitate the second processing, the method according to in the present embodiment may include step S105.

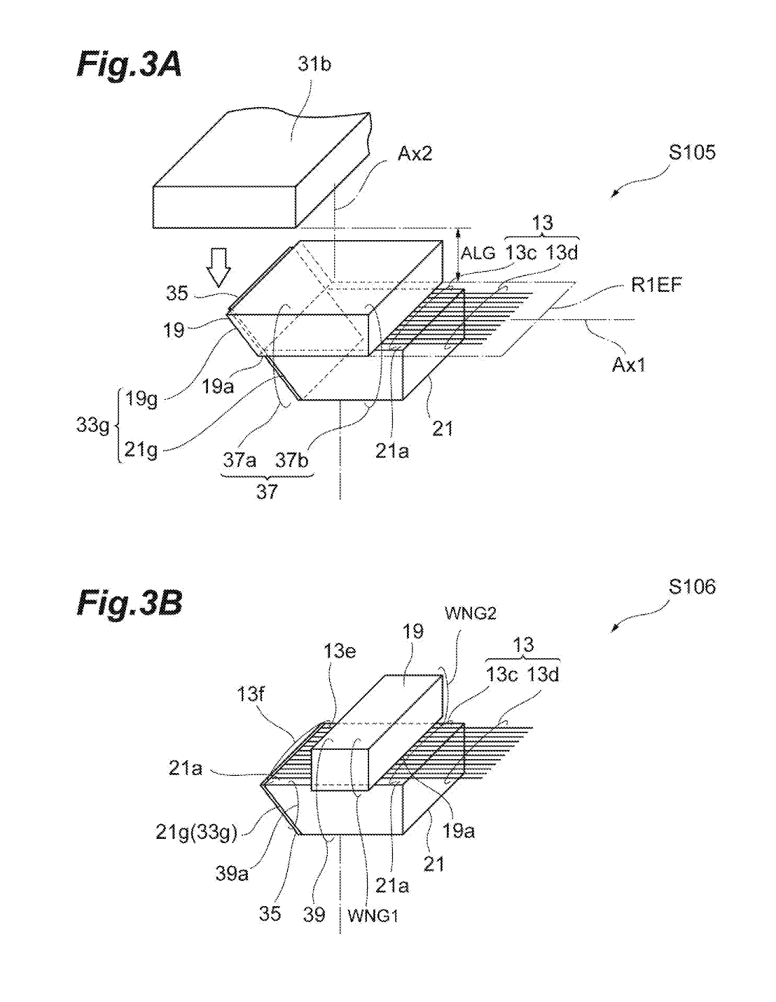

Step S105 includes, as shown in FIG. 3A, prior to the second processing, arranging the second processing device 31b and the third intermediate product 37 in the direction of the second axis Ax2, and then in the positioning ALG, positioning one of the second processing device 31b and the first part 19 of the third intermediate product 37 to the other. Specifically, one of the second processing device 31b and the first face 19a of the first part 19 of the third intermediate product 37 is positioned with respect to the other. For example, positioning the second processing device 31b to the first face 19a can determine an amount of the second processing, which is estimated with respect to the first face 19a, in processing the first part 19 of the third intermediate product 37 with the second processing device 31b. The third intermediate product 37 provides the first part 19 with the first face 19a that can be used as a reference near the arrangement of the optical fibers 13. Specifically, the first face 19a of the first part 19 makes contact with the optical fibers 13 to firmly support the arrangement of the optical fibers 13. In the present embodiment, the first face 19a of the first part 19 supports the optical fibers 13, which are in the grooves 23 on the first face 21a of the second part 21. The optical fibers 13 and the first face 19a in the third intermediate product 37 are arranged along a reference plane. Such a first part 19 is provided with the first face 19a that can be used as a reference for the second processing.

Step S106 includes, as shown in FIGS. 3A and 3B, moving one of the second processing device 31b and the third intermediate product 37 relative to the other in the direction of the second axis Ax2 to apply the second processing to the third intermediate product 37, and the second processing machines the third intermediate product 37 to the optical fibers 13 with reference to the first face 19a of the first part 19, so that the third intermediate product 37 is processed at the first end portion 37a thereof. The first end portion 37a includes a face 33g with a portion inclined with respect to the first reference plane REF. The second processing can produce the fourth intermediate product 39 from the third intermediate product 37. The positioning in step S105 makes the second processing easy.

In the second processing, the optical fibers 13 are held by the first and second parts 19 and 21 between the first faces 19a and 21a so as to extend in the direction the first axis Ax1. Processing the third intermediate product 37, which has the arrangement of the first and second parts 19 and 21 in the direction of the second axis Ax2, in the second processing machines the third intermediate product 37 by moving one of the second processing device 31b and the third intermediate product 37 relative to the other in the direction of the second axis Ax2, so that the second processing device 31b reaches the side face of the cladding 13cd of each of the optical fibers 13, which extends in the direction of the first axis Ax1, and machines each optical fiber 13 at the side face of the cladding 13cd in the direction from the cladding 13cd toward the core 13cr. Stopping the second processing device 31b at an endpoint in the second processing determines the position of the cladding face 13e.

The optical fiber 13 provides the first optical fiber portion 13c thereof with a part which is disposed in the first end portion 37a of the third intermediate product 37, and this part is subjected to the second processing at the cladding 13cd to machine the cladding 13cd to the end portion 13f of the optical fiber 13. The second processing machines the first part 19, the arrangement of the optical fibers 13, and the reflecting member 35. This processing leaves the reflecting member 35 thus processed, which allows the reflection of light beams at the inclined ends of the optical fibers 13, on the inclined face 33g of the second part 21, and provides the optical fibers 13 with the cladding faces 13e thereof, so that the first part 19 is provided with wing parts (W1NG and W2NG) protruding outward beyond the respective sides of the second part 21. This processing produces the first end 39a of the fourth intermediate product 39 at the first end portion 37a of the third intermediate product 37. In contrast, the second processing does not change the second end 37b of the third intermediate product 37, which is referred to as the second end 39b in the fourth intermediate product 39, and does not process the second part 21.

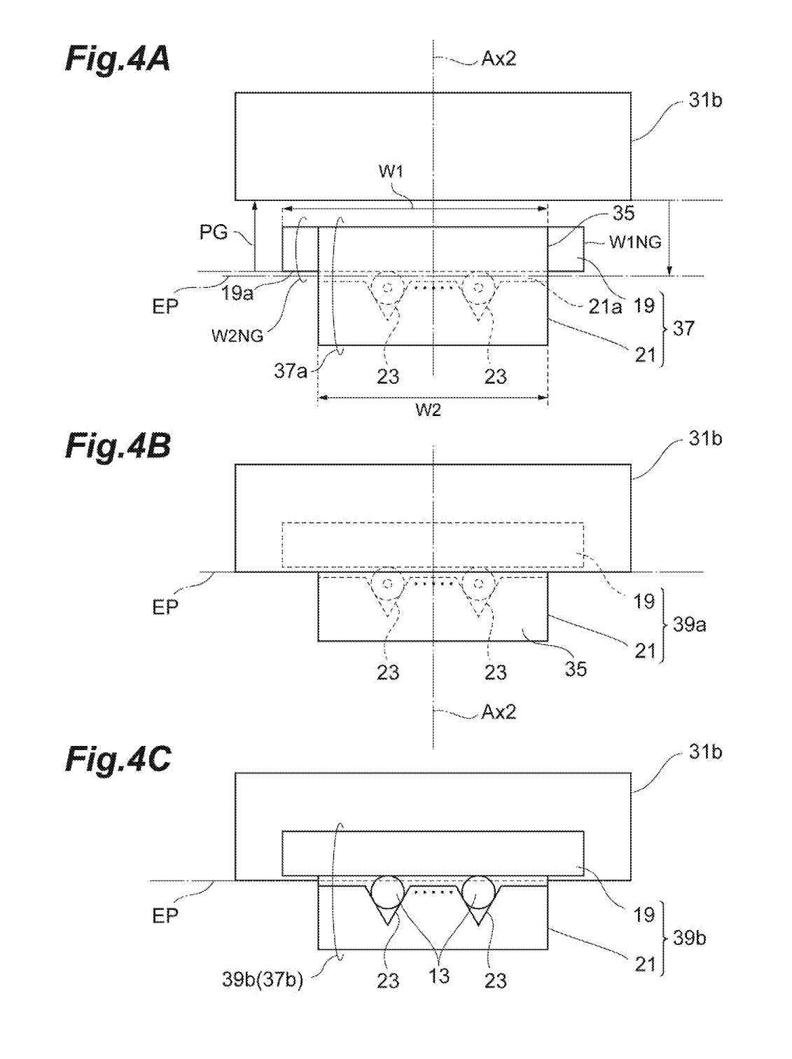

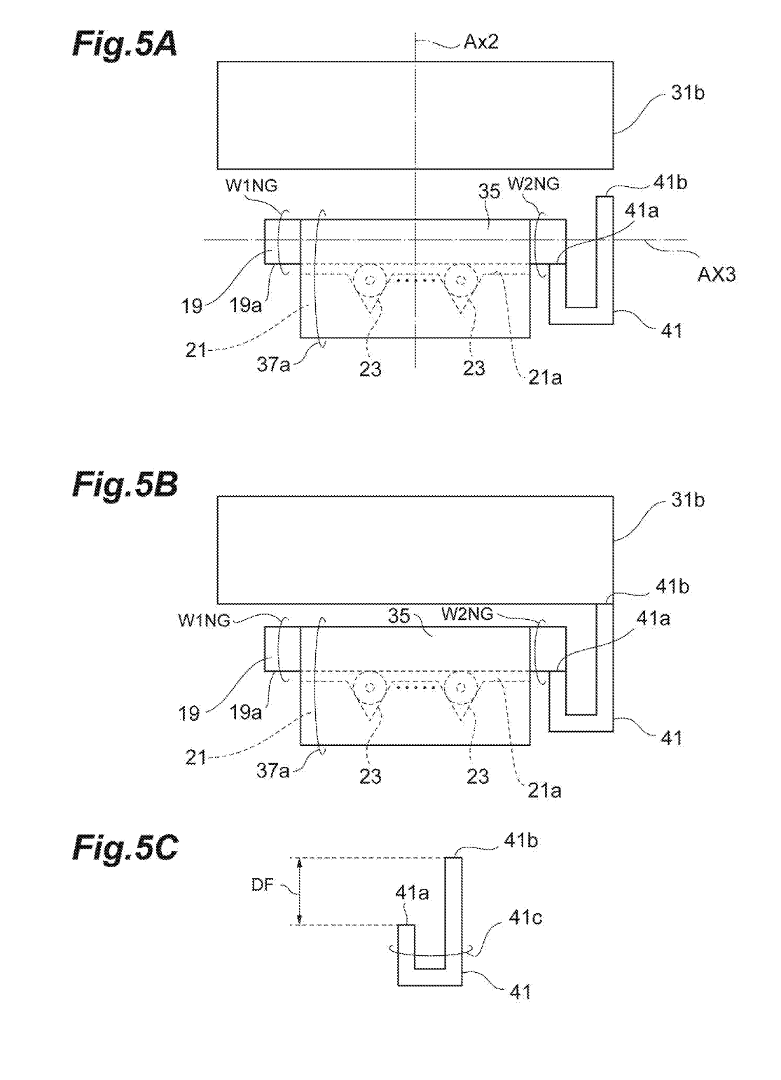

With reference to FIGS. 4A, 4B, 4C, 5A, 5B and 5C, a detail description will be given of the second processing according to the embodiment before that of the subsequent step. Referring to FIG. 4A, the second processing device 31b are shown along with the third intermediate product 37, which includes the arrangement of the first end portion 37a. The second processing device 31b is positioned to the third intermediate product 37 to be disposed at a position PG determined with reference to the first face 19a of the first part 19. This positioning results in that the second processing device 31b is opposed to the first face 19a of the first part 19 and is spaced apart from the first face 19a of the first part 19. The second processing device 31b is moved, as shown in FIG. 4B, to process the first part 19 and the optical fibers 13 of the third intermediate product 37 to a position EP, which has been determined with respect to the first face 19a of the first part 19. Moving the second processing device 31b allows the second processing device 31b to reach the first face 19a of the first part 19 and then to start to machine the first part 19 at the first face 19a. The end point EP in machining the third intermediate product 37 is close to the first face 19a of the first part 19. This processing can machine the first end portion 37a of the third intermediate product 37 to form the first end 39a of the fourth intermediate product 39. In contrast, the second end 37b of the third intermediate product 37 is not subjected to the processing to be unchanged, as shown in FIG. 4C, and becomes the second end 39b of the fourth intermediate product 39.

This embodiment, as shown in FIG. 4A, uses the first face 19a of the first part 19 of the third intermediate product 37 as a reference to determine the distance from the initial position of the second processing device 31b to the optical fibers 13. In processing the third intermediate product 37 that includes the first and second parts 19 and 21 arranged in the direction of the second axis Ax2, moving one of the third intermediate product 37 and the second processing device 31b relative to the other, as shown in FIG. 4B, can process the first part 19. This movement allows the second processing device 31b to reach the side face of the optical fibers, which extend in the direction of the first axis Ax1.

The first part 19 is provided with the first face 19a, the width of which is larger than that of the first face 21a of the second part 21 by more than 0.1 millimeter, so that the second part 21 protrudes with respect to at least one of the side faces of the first part 19, and the second part 21 of the slightly larger width allows the measurement of the travel distance of the second processing device 31b. In the present embodiment, the difference between the first width W1 of the first face 19a and the second width W2 of the first face 21a is greater than 0.1 millimeter.

As shown in FIGS. 5A and 5B, the first part 19 of the third intermediate product 37 is provided with the first face 19a that extends in the direction of the third axis Ax3 intersecting the second axis Ax2 (and the first axis Ax1) and includes a portion of the first width W1 larger than the second width W2 of the first face 21a of the second part 21. The first part 19 in the third intermediate product 37 is provided with wing portions (W1NG and W2NG) protruding outward with respect to the respective side faces of the second part 21. These wing portions of the first part 19 can easily determine the distance from the initial position of the second processing device 31b to the optical fibers 13 by use of the wide first face 19a thereof.

In particular, this positioning can be done by a positioning device 41 as shown in FIG. 5C. The positioning device 41 can determine the initial position of the second processing device 31b with respect to the first face 19a of the first part 19. The positioning device 41 includes a first ranging end 41a, a second ranging end 41b, and a base 41c which supports the first and second ranging ends 41a and 41b on both ends thereof. The base 41c maintains a positional difference DF between the first and second ranging ends 41a and 41b. The second processing device 31b and the third intermediate product 37 are arranged such that the first part 19 makes contact with the first ranging end 41a at the first face 19a thereof, and the second processing device 31b makes contact with the second ranging end 41b at the reference face thereof. The positioning device 41 may be made of material, such as metal. The positioning device 41 allows accurate machining with respect to the first face 19a of the first part 19, and the machining accuracy is independent of the thickness of the first part 19 and variations in its thickness.

The grooves 23, which receive the optical fibers 13, may be disposed not on the first face 19a of the first part 19 but on the first face 21a of the second part 21. The grooves 23, which extend in the direction of the first axis Ax1 on the first face 21a of the second part 21, support the respective optical fibers 13 by the first and second faces 19a thereof. Accordingly, the first face 19a does not have any grooves for the optical fibers but acts to support the optical fibers 13. The optical fibers 13 in the third intermediate product 37 are arranged along the first face 19a of the first part 19, which is used as a reference for the processing.

The second processing produces the fourth intermediate product 39. In the present embodiment, as shown in FIG. 3B, the first part 19 is provided with the wings W1NG and W2NG, which extend beyond the side faces of the second part 21 (in the third axis Ax3).

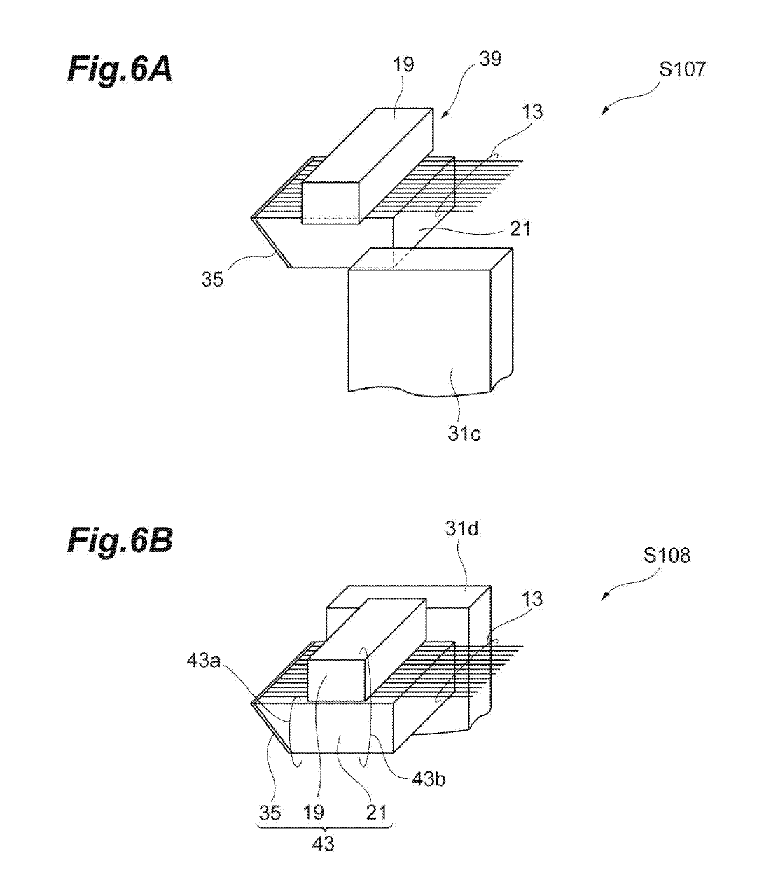

If necessary, in step S107, as shown in FIG. 6A, one of the third processing device 31c and the fourth intermediate product 39 can be moved relative to the other to remove the wing W1NG by machining. Further, in step S108, as shown in FIG. 6B, one of the fourth processing device 31d and the fourth intermediate product 39 can be moved relative to the other to remove the wing W2NG by machining.

The above steps bring the optical connecting device 43 to completion. The optical connecting device 43 has a first end portion 43a and a second end portion 43b. The first and second end portions 43a and 43b of the optical connecting device 43 has the substantially same structure as the first and second end portions 39a and 39b of the fourth intermediate product 39 except for the removal of the protrusions in the optical connecting device 43.

The first part 19, the second part 21 and the reflecting member 35 of the fourth intermediate product 39 can be machined to eliminate the protruding portion, such as the wing W1NG, from the fourth intermediate product 39. The optical connecting device 43 includes the first part 19 and the second part 21 that have been processed, which have substantially the same width in the direction of the third axis Ax3.

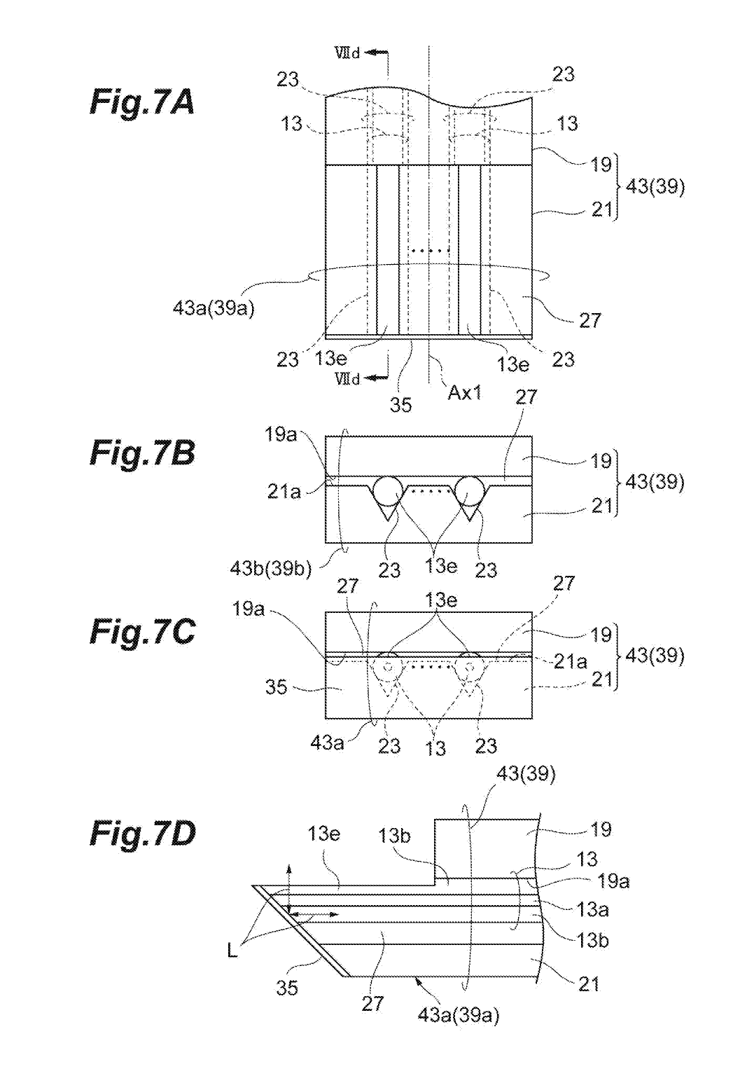

FIGS. 7A, 7B, 7C and 7D are views showing the optical connecting device according to the embodiment. The fourth intermediate product 39 has substantially the same appearance as that of the optical connecting device 43 except for the disappearance of the protrusions (W1NG and W2NG) in the optical connecting device 43. FIG. 7A is a plan view showing the first end portion 43a of the optical connecting device 43. The cladding faces 13e, which are formed by the second processing, of the optical fibers 13 extend in alignment with the positions of the optical fibers 13. FIG. 7B is a rear view showing the second end portion 43b of the optical connecting device 43. In the second end portion 43b (39b), the first and second parts 19 and 21 firmly hold the optical fibers 13, and orient the optical fibers 13, reaching the first end portion 43a, in the direction of the second axis Ax2. FIG. 7C is a front view showing the first end portion 43a of the optical connecting device 43. In the first end portion 43a, the reflecting member 35 covers the second part 21 and the ends of the optical fibers 13. FIG. 7D is a cross-sectional view taken along line VIId-VIId shown in FIG. 7A. The end of each optical fiber 13 reflects light L. Light propagating in the optical fiber 13 is reflected by the fiber end to pass through the cladding face 13e. Light coning in the optical fiber 13 through the cladding face 13e is reflected by the fiber end to propagate through the optical fiber 13.

The method for fabricating an optical connecting device provides the cladding of the optical fiber with the side face for optical coupling.

Having described and illustrated the principle of the invention in a preferred embodiment thereof, it is appreciated by those having skill in the art that the invention can be modified in arrangement and detail without departing from such principles. We therefore claim all modifications and variations coining within the spirit and scope of the following claims.

What is claimed is:

1. A method for fabricating an optical connecting device comprising:
preparing a product for an optical connecting device, the product including a first part and a second part for a holder, and one or more optical fibers extending in a direction of a first axis, the first part and the second part of the product being arranged in a direction of a second axis such that the one or more optical fibers are between a first face of the first part and a first face of the second part, the second axis intersecting the direction of the first axis, the first face of the first part and the first face of the second part extending in the direction of the first axis and a direction of a third axis, and the third axis intersecting the direction of the first axis and the direction of the second axis; and
moving one of a processing device and the product relative to the other to process the product in the direction of the second axis so as to reach the optical fibers.

2. The method according to claim 1, further comprising, prior to moving one of the processing device and the product relative to the other to process the product, positioning the first face of the first part of the product to the processing device.

3. The method according to claim 1,
wherein moving one of a processing device and the product relative to the other to process the product includes moving the processing device to process the first part of the product to an endpoint, and the endpoint being determined with respect to the first face of the product.

4. The method according to claim 1,
wherein the first face of the first part includes an area having a width larger than that of the first face of the second part in the direction of the third axis.

5. The method according to claim 1,
wherein
the first face of the first part has a first width, the first face of the second part has a second width smaller that the first width, and
a difference between the first width and the second width is larger than 0.1 mm.

6. The method according to claim 1,
wherein
the first face of the first part extends along a reference plane intersecting the second axis,
the second part has grooves that receive the optical fibers therein, and
the grooves extend in the direction of the first axis.

7. The method according to claim 1,
wherein
the optical fibers are arranged along a first reference plane,
the product has a first end and a second end that are arranged in the direction of the first axis,
the first end is opposite to the second end,
the first part has a first end face in the first end, and the first end face extends along a second reference plane inclined to the first reference plane,
the optical fibers each have an end at the first end face, and
moving one of a processing device and the product relative to the other to process the product includes processing the first end of the product.

8. The method according to claim 7,
wherein
the product further has a reflecting member on the first end face, and
moving one of a processing device and the product relative to the other to process the product includes processing the reflecting member.
